(19) United States
(12) Patent Application Publication
(10) Pub. No.: US 2025/0229542 A1
(43) Pub. Date: Jul. 17, 2025

(54) METHOD FOR PRINTING A CONTAINER, AND APPARATUS FOR PRINTING A CONTAINER

(71) Applicant: KRONES AG, Neutraubling (DE)

(72) Inventors: Sven Kerpe, Linkenheim-Hochstetten (DE); Thomas Schnitger, Eisenach (DE); Alexandra Lyashenko, Regensburg (DE)

(21) Appl. No.: 18/852,812

(22) PCT Filed: Apr. 28, 2023
(86) PCT No.: PCT/EP2023/057931

§ 371 Date: Sep. 30, 2024

(30) Foreign Application Priority Data
Apr. 5, 2022 (DE) 10 2022 108 149.4

(51) Int. Cl. B41J 2/21; B41J 3/407; B41J 11/00

(52) U.S. Cl. CPC B41J 2/2128; B41J 3/40733; B41J 11/002

(57) ABSTRACT

A method for printing a container, such as a bottle, with a printing image using one inkjet print head per ink, the method comprising determining an ink quantity to be applied to the container in a manner which is dependent on the printing image to be applied for each ink, and applying the ink quantity to be applied by each inkjet print head, wherein at least one of the inkjet print heads applies the ink quantity to be applied to the container in two printing operations, wherein a partial ink quantity is applied to the container in each printing operation in a manner which is dependent on the ink quantity to be applied, wherein the partial ink quantity in each printing operation corresponds to up to the maximum ink quantity which can be ejected by the inkjet print head.

### TECHNICAL FIELD

The present invention relates to a method for printing a container, such as a bottle, with a printing image using one inkjet print head per ink, and to an apparatus for printing containers, such as bottles, with a printing image, wherein the apparatus comprises one inkjet print head for ejecting an ink and a control unit for controlling the ejection of ink by the respective inkjet print heads.

### BACKGROUND AND SUMMARY

Apparatuses for printing containers, such as bottles, are known in principle from prior art. As is known, it is also possible to use inkjet print heads for this purpose, which distribute ink droplets of appropriate size on the surface of the container with pixel precision, depending on the ink quantity to be applied. For this purpose, inkjet print heads are known to comprise a plurality of separately controllable and operable nozzles, from each of which an ink droplet can be ejected. This allows for a pixel-precise ejection of printing ink.

Inkjet print heads apply the necessary ink quantity by accumulating smaller ink droplets to form a larger ink droplet, for example by operating the relevant printing nozzle or a piezoelectric element assigned thereto. For example, a control signal can be transmitted to the piezoelectric element, which causes a mechanical movement of this element, causing ink to be ejected from the nozzle. Depending on the control signal, large and small ink droplets can be produced.

In principle, this allows for a variable adjustment of the ink quantity ejected and thus of the color produced on the container.

Multi-color printing typically uses different inkjet print heads, wherein each inkjet print head ejects exactly one ink. For example, an inkjet print head can eject for ejecting white or black (hereinafter also referred to as inks) and other print heads can apply magenta or yellow, for example. Inkjet print heads are also known which can eject multiple inks, for example two or four.

Since several small ink droplets are combined to create one ink droplet, the creation of a specific color is possible only in a range from 0 (no ink ejected) to the maximum ink quantity which can be ejected by the print head (i.e., the ink quantity which can be ejected by each nozzle). The ink droplet size cannot be adjusted continuously; rather, the smaller droplets that form the large droplet can only be produced in a certain discrete volume.

This limits the color space achievable by inkjet print heads (i.e., the gradation from 100% to 0, i.e., no ink ejected), which allows only limited flexibility when creating printing images, in particular their color gradation, on containers. At the same time, on transparent substrates (e.g., PET containers) but also on colored or dyed substrates or colored backgrounds, the achievable opacity or color intensity of the printed inks may be too low for part of this color space, which can have a detrimental effect on the quality or recognizability of the printing images applied.

### Object

Based on the known prior art, the technical object to be achieved is thus to provide a method for printing a container that is as flexible as possible and at the same time ensures adequate quality of the printing images applied. The object may additionally be to improve the opacity of the printing images applied and/or to increase the color space available for applying printing images.

### Solution

This object is achieved by the method for printing a container, such as a bottle, with a printing image, and by the apparatus for printing containers, such as bottles, with a printing image as described herein.

The method according to the invention for printing a container, such as a bottle, with a printing image using one inkjet print head per ink comprises determining an ink quantity to be applied to the container in a manner which is dependent on the printing image to be applied for each ink, and applying the ink quantity to be applied by each inkjet print head, wherein at least one of the inkjet print heads applies the ink quantity to be applied to the container in two printing operations, wherein a partial ink quantity is applied to the container in each printing operation in a manner which is dependent on the ink quantity to be applied, wherein the partial ink quantity in each printing operation corresponds to up to the maximum ink quantity which can be ejected by the inkjet print head.

In the following, an inkjet print head is understood to mean inkjet print heads that are already in principle known from the prior art. They have a number of printing nozzles which can be operated individually to eject ink droplets of different size. The inkjet print head is usually assigned exactly one ink supply, via which all nozzles of said inkjet print head are supplied with printing ink of exactly one color.

In addition, the term inkjet print head is also to be understood to mean an embodiment in which a print head as a structural unit comprises a number of inkjet printing nozzles, but wherein one group of inkjet printing nozzles is each assigned one ink supply, so that the print head comprises a first group of inkjet printing nozzles, which are provided with printing ink of a first color from a first ink supply, and a second group of inkjet printing nozzles, which are provided with printing ink of a possibly different second color from a second ink supply. In the following, the respective groups of inkjet printing nozzles are also referred to as “inkjet print heads.”

In the following, the ink quantity to be applied or the partial ink quantity to be applied always means the ink quantity to be ejected by a relevant nozzle of an inkjet print head to produce a relevant ink pixel of the (optionally multi-color) printing image. Since this can vary from pixel to pixel and therefore also from nozzle to nozzle of the inkjet print head, the total ink quantity to be applied does not have to be an integer multiple of the ink quantity ejected by a specific nozzle of the inkjet print head. For the sake of simplicity, however, in the following reference is made to the ink quantity or partial ink quantity to be applied by the inkjet print head in each printing operation, although this also means the ink quantity or partial ink quantity to be applied by a relevant nozzle of the inkjet print head.

The fact that the partial ink quantity in each printing operation corresponds to the maximum ink quantity which can be applied by the inkjet print head (or a relevant nozzle) is to be understood here to mean that in the two consecutive printing operations, the maximum ink quantity which can be ejected can be output by one nozzle in each case. The maximum ink quantity which can be ejected can be determined either by structural edge conditions of the printing nozzle or the print head or by program control (e.g., depending on a control signal).

With the method according to the invention, it is now possible to increase the achievable color space and thus to apply more diverse printing images or to improve their quality in terms of contrast and the like. At the same time, the maximum ink quantity which can be applied, which corresponds to twice the maximum ink quantity which can be applied by the relevant inkjet print head during one printing operation, can improve the opacity of the applied printing images, which is advantageous when printing on transparent substrates but also on colored or dyed substrates.

In one embodiment, it is provided for at least two inkjet print heads to eject an ink droplet from a printing nozzle in a printing operation and for the size of the ink droplet to be determined as a function of the partial ink quantity to be applied, wherein the size of the ink droplet can be adjusted in discrete partial steps from 0 up to a maximum ink droplet size as a function of the partial ink quantity to be applied.

With this embodiment, the advantage according to the invention can also be realized for different inks.

Furthermore, the method may comprise adjusting the ink quantity ejected by the at least two inkjet print heads.

In particular, this adjustment can be done in a step before the actual printing process and only once. Different inkjet print heads, in particular inkjet print heads of different models or different manufacturers, do not necessarily apply the same maximum ink quantity or vary in terms of the droplet sizes they can produce and also the intermediate sizes of the ink droplets that may be achievable. This deviation, which can otherwise lead to reduced print quality, can be compensated for by, for example, linear ink scaling or linear adjustment and, if necessary, an adjusted ink profile of the ink droplet quantities ejected.

In particular, it can be provided for the at least two inkjet print heads to be able to eject maximum ink droplet sizes that differ from one another and for the adjustment to be carried out based on the maximum ink droplet sizes. This embodiment allows for evening out ink droplets of different sizes which can be ejected by different inkjet print heads.

It can further be provided for the adjustment to comprise changing a control signal (also referred to as waveform) for at least one inkjet print head. Control signals are usually used here to control piezo elements assigned to individual printing nozzles, which in turn has a direct influence on the ejection of ink droplets. By specifically changing these control signals, it is possible to adjust, for example, the size of the ink droplets.

In one embodiment, the determination comprises deriving color values from the printing image to be ejected, wherein the color values correspond from 0 up to a maximum color value corresponding to the maximum ink quantity which can be ejected by the inkjet print head, and determination further comprises doubling the derived color values, wherein the ink quantity to be applied is determined based thereon.

While a printing image to be applied can itself specify a certain color value, which would also require a certain ink droplet size, the additional (control-related) doubling of the color value to be achieved can also increase the ink quantity to be applied. Since twice the ink quantity can be applied in the two consecutive printing operations, the relative color intensity of the resulting printing image can be kept constant, wherein the opacity of the printing image ejected is improved at the same time.

Furthermore, it can be provided for determination to comprise deriving color values from the printing image to be ejected, wherein the color values correspond from 0 to twice a maximum color value corresponding to the maximum ink quantity which can be ejected by the inkjet print head, wherein the ink quantity to be applied is determined based thereon.

With this embodiment, the color space is increased because the color space is not defined by the maximum ink quantity which can be ejected by the inkjet print head, but at least twice that amount. This method can also be advantageously continued by selecting color values between 0 and 3 times or 4 times or 5 times or generally n times and determining the ink quantity to be ejected based thereon.

In particular, determining the ink quantity to be applied may further comprise determining the partial ink quantity to be applied as a function of the ink quantity to be applied.

This means that the partial ink quantity to be applied can be determined individually for each printing operation.

In one embodiment, the ink quantity to be ejected corresponds to at least twice the value of a minimum ink quantity which can be ejected by the inkjet print head, and the partial ink quantity for each printing operation corresponds to at least the minimum ink quantity which can be ejected by the inkjet print head. Alternatively, it can be provided for the ink quantity to be ejected to correspond to at least twice the value of a minimum ink quantity which can be ejected by the inkjet print head and for the partial ink quantity for a printing operation to be selected to be as large as possible depending on the ink quantity to be ejected and the maximum ink quantity which can be ejected by the inkjet print head, wherein, if the ink quantity to be ejected corresponds to more than the maximum ink quantity which can be ejected by the inkjet print head, the difference between the ink quantity to be applied and the maximum ink quantity which can be ejected is defined as the partial ink quantity in the second printing operation.

The first variant achieves a preferably even application of the entire ink quantity. For example, if the ink quantity to be applied is 6 times the minimum ink quantity which can be ejected by the inkjet print head, 3 times the minimum ink quantity which can be ejected by the inkjet print head can be ejected as an ink droplet in each printing operation, creating two layers of equal thickness. Unwanted color reflections caused by different thicknesses of color layers can thus be avoided. The second embodiment can ensure that the substantial part of the ink quantity to be applied is ejected during one of the printing operations. Effects that are detrimental in particular to small ink droplets ejected (e.g., airflow) can be reduced in this way.

In one embodiment, the method further comprises curing the applied partial ink quantity by a curing device after each printing operation. Curing does not have to take place after each of the printing operations. Alternatively, it may also be provided for curing to only take place after a second printing operation or, if provided, a third printing operation. Curing after each or only every second printing operation can be provided for based on the ink used and, in particular, its properties, such as viscosity, and can also be provided depending on the substrate, the printing speed, etc.

Curing after each printing operation prevents the printing ink already applied, or the printing ink ejected during the subsequent printing operation, from smearing, splattering, bleeding or mixing with other inks in the subsequent printing operation, which will improve the quality of the overall printing image.

The apparatus according to the invention for printing containers, such as bottles, with a multi-color printing image comprises an inkjet print head for ejecting an ink and a control unit for controlling the ejection of ink by the respective inkjet print heads, wherein the apparatus is configured to carry out a method for printing a container with a multi-color printing image, the method comprising determining an ink quantity to be applied to the container in a manner which is dependent on the printing image to be applied for each ink, and applying the ink quantity to be applied by each inkjet print head, wherein at least one of the inkjet print heads applies the ink quantity to be applied to the container in two printing operations, wherein a partial ink quantity is applied to the container in each printing operation in a manner which is dependent on the ink quantity to be applied, wherein the partial ink quantity in each printing operation corresponds to up to the maximum ink quantity which can be ejected by the inkjet print head.

This apparatus allows for more flexible and better quality printing.

In particular, the apparatus can comprise a curing device which is arranged such that a partial ink quantity ejected can be cured after each printing operation. By providing a corresponding curing device, splattering of printing ink applied in a first printing operation can be avoided.

### BRIEF DESCRIPTION OF THE FIGURES

FIG. 1 shows an apparatus for printing a container according to one embodiment;

FIG. 2 shows a flowchart of a method for printing a container according to one embodiment;

FIGS. 3a and 3b show further embodiments for determining the ink quantity to be applied for each ink;

FIG. 4 shows a flowchart of a method for adjusting the ink quantities for different print heads.

### DETAILED DESCRIPTION

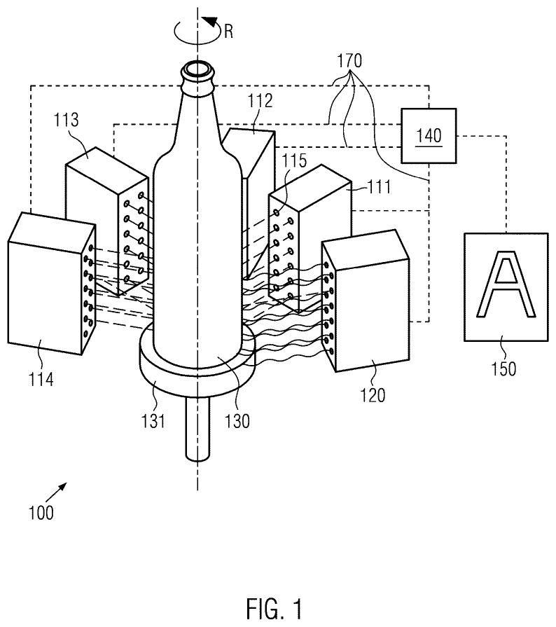

FIG. 1 shows an apparatus 100 for applying a multi-color printing image to a container 130, such as a bottle or a can. In the embodiment shown here, the apparatus comprises a turntable 131 on which a container can be positioned and rotated about the axis of rotation R. In particular, the axis of rotation R can be parallel to the longitudinal axis of the container from the bottom to the mouth of the container 130 or can coincide with said longitudinal axis. Other embodiments of positioning and moving the container are also conceivable, so that the invention is not limited in this respect.

While methods and apparatuses for printing three-dimensional objects, in particular (beverage) bottles, tubes, drinking glasses or cans, are described below, the described embodiments are not limited to printing on curved surfaces of containers. In particular, printing on flat and curved surfaces can be carried out using the described methods and apparatuses. Furthermore, substrates that are not containers, such as paper or film, can also be printed.

The apparatus 100 further comprises at least one or more inkjet print heads 111-114 (hereinafter also referred to only as print heads), each of which has a plurality of printing nozzles 115 which can be controlled separately and can eject ink droplets of variable size. Each of the inkjet print heads can be provided to eject exactly one color of the multi-color printing image. For example, the inkjet print head 111 can be configured to eject black, the inkjet print head 112 can be configured to eject cyan, the inkjet print head 113 can be configured to eject magenta, and the inkjet print head 114 can be configured to eject yellow. For this purpose, ink reservoirs can be assigned to the inkjet print heads in a known manner, since the ink can be supplied to the inkjet print heads.

While exactly four print heads 111-114 are shown here, more or fewer print heads can be provided. For example, more or fewer print heads may be provided depending on the number of colors to be applied or the area to be printed on the container. Instead of being arranged one after the other in the direction of rotation of the container as shown herein, the print heads can also be arranged vertically offset from one another and/or on different levels. In particular, a first number of print heads can be arranged on a vertical plane and a second number of print heads can be arranged on a second plane, which can eject different or the same inks.

Optionally, the apparatus 100 can also comprise at least one curing device 120, which can cause the printing inks to dry, for example by ejecting UV radiation or infrared radiation or heat.

The apparatus 100 further comprises a control unit 140 which is connected via suitable data connections 170 to at least the inkjet print heads 111-114 and optionally to the curing device 120 and optionally to the turntable 131 in order to transmit control signals to these respective devices for control.

The control signals for the inkjet print heads 111-114 can in particular be control signals that can selectively control piezo elements or other operating elements that are assigned to each printing nozzle 115. In conventional inkjet print heads, each printing nozzle is assigned one piezo element that is operated in accordance with a control signal (e.g., a voltage curve) and can mechanically and/or acoustically cause one or more small ink droplets to be ejected, which together form an ink droplet corresponding to the ink quantity to be ejected by this printing nozzle. The inkjet print heads can usually eject ink quantities (per printing nozzle) starting from a value of 0 (i.e., no ink quantity ejected by a printing nozzle) up to a maximum ink quantity corresponding to a maximum droplet size which can be ejected by a printing nozzle. The resulting ink droplet size ejected by a printing nozzle can usually be adjusted in steps between these extreme values. For example, the piezo element can be operated by suitable control signals such that it can eject seven intermediate steps and thus seven different droplet sizes. However, it is also possible to have print heads that do not implement gradation, i.e., that can either eject no ink (value 0) or the maximum droplet size (in that case the only droplet size). The invention is not limited with regard to the number of intermediate stages.

The control unit 140 can comprise a data memory (not shown) in which, for example, the multi-color printing image to be applied to the container can be stored in the form of a file. The control unit can in particular be configured to derive color values from the multi-color printing image or the file 150 in order to determine the ink quantities to be ejected by the individual inkjet print heads and in particular their printing nozzles 115 based on these color values.

Based on the ink quantities to be ejected or applied to the container (each per printing nozzle), the control unit can then send corresponding control signals to the respective inkjet print heads, which then cause the ink quantity to be applied to the containers to be ejected by the respective printing nozzles. According to the invention, it is provided for each of the inkjet print heads to be configured to eject the maximum ink quantity which can be ejected by the inkjet print head (i.e., by each printing nozzle of the print head), even if the container is moved past the relevant print head several times.

According to the invention, it is provided for at least one of the inkjet print heads to carry out two printing operations on the container in order to apply part of the multi-color printing image, in particular the color to be applied to the container by this inkjet print head. According to the invention, said inkjet print head can thus apply ink to a specific point on the container that corresponds to up to twice the maximum ink quantity which can be ejected by the inkjet print head per printing operation.

For this purpose, the container can, for example, be rotated twice completely around the axis of rotation R on the turntable 131, so that the same surface piece of the container is moved past the print head twice and can be printed on. It can also be provided for the curing device 120 to cause drying or generally curing of the printing ink (for example, but not necessarily with UV light or infrared light or visible light) on the container 130, so that the printing ink applied in the subsequent printing operation does not cause smearing or splattering or bleeding or mixing or blending with the printing ink already applied in the previous printing operation. While only one curing device is shown herein, a curing device can also be arranged between each two adjacent print heads.

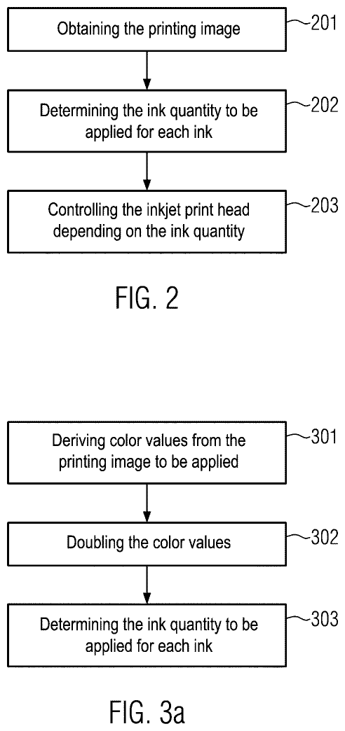

FIG. 2 shows a method for controlling the inkjet print heads to eject ink quantities through the individual printing nozzles based on a printing image to be applied to the container. The method comprises, in a first step 201, obtaining a printing image. This can be achieved, for example, by storing the printing image 150 in the control unit 140 or memory assigned thereto.

Based on the obtained printing image, the ink quantity for each ink to be applied is then determined in step 202. As already mentioned, said ink quantity refers to the ink quantity to be applied by a particular printing nozzle at a specific point on the container and can be different for each printing nozzle as well as for specific points on the container for one and the same ink. The ink quantity to be applied is usually determined on the basis of the ink information of the printing image. The information encoded in the image, for example the pixel values regarding brightness and color for individual pixels, is evaluated and the ink quantity to be applied is determined based thereon. A pixel of a specific ink with, for example, a maximum color value also corresponds to a maximum ink quantity to be applied for said pixel; lower color values correspond to smaller ink quantities.

With the information thus obtained, each inkjet print head and each printing nozzle of the relevant inkjet print head is then controlled 203 such that the ink quantity to be applied is applied to the correct position of the container. This can typically be done while the container is rotated on the turntable 131 and can be configured as a continuous process. Alternatively, it can also be provided for the container to be fixed in a specific position and for the respective print heads to eject the ink quantities intended for this position to the suitable places on the container.

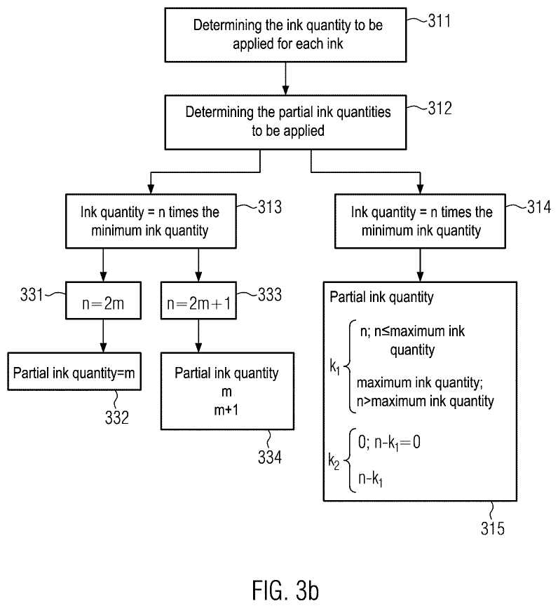

This approach applies in principle. However, in the event that one of the inkjet print heads performs two printing operations on the container (for example, by rotating the container such that the same surface is guided past the print head twice), partial ink quantities are determined for each of the printing operations in accordance with this method, as will also be further described with reference to FIG. 3.

A more specific method compared to FIG. 2 is described in the flowchart of FIG. 3a.

According to this method, in step 301, the color values are first derived from the printing image to be applied. However, instead of using them directly to determine the ink quantity to be applied, these color values are first doubled (step 302). Alternatively, the original color values (e.g., 8 bit) can be used together with a doubled number of ink droplets. These doubled color values or the original color values together with the doubled droplet numbers are then used to determine, in step 303, the ink quantities to be applied for each ink and correspondingly for each print head or the individual printing nozzles.

Since it is provided, according to the invention, that at least one of the print heads can carry out two printing operations on a container in succession with up to the maximum ink quantity, this embodiment with doubled color values can increase the opacity of the relevant color on the container without, however, changing the relative strength of the colors to one another. The embodiment of FIG. 3a can in principle be combined with all other embodiments.

It should also be noted that instead of doubling the color values, it is also conceivable to triple or quadruple the color values or generally multiply the color values by n. The same applies to doubling the number of ink droplets. In order to realize these color values according to the necessary ink quantity, the container must be printed on by the print head in three printing operations or four printing operations or n printing operations. This can be done according to the methods described for doubling the color values and requires an additional printing operation, which can be carried out with up to the maximum ink quantity.

FIG. 3b describes another flowchart of a method for determining the ink quantities to be applied in the individual printing operations. The ink quantities to be applied in individual printing operations are also referred to as partial ink quantities. As already described, digital print heads can typically eject ink droplets with an ink droplet volume or ink droplet size that can vary in discrete partial steps starting from a minimum ink quantity or ink droplet size up to a maximum ink quantity or ink droplet size of the relevant printing nozzle. For the sake of simplicity, it is assumed that these discrete partial steps or partial ink quantities differ by a constant minimum ink quantity, so that a partial ink quantity which can be ejected by a printing nozzle during one printing operation corresponds to any integer multiple of the minimum ink quantity and is less than or at most equal to the maximum ink quantity for a print droplet.

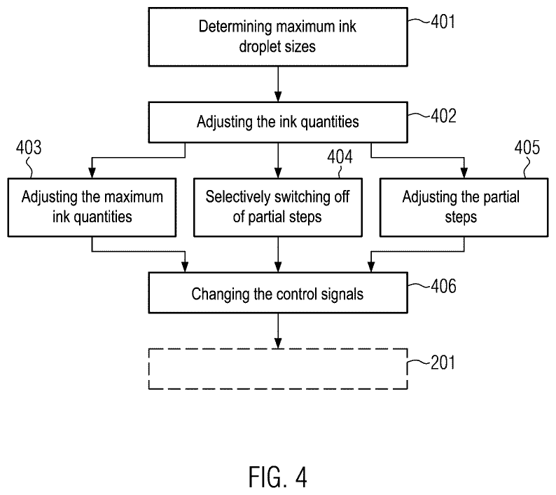

This assumption generally does not apply to real print heads, so that the discrete, differently sized achievable ink droplets do not have the same size differences. However, this can be compensated for by adjusting the ink quantities, as described with reference to FIG. 4.

However, for the sake of simplicity it is ideally assumed that the difference between ink droplets of different sizes is an integer multiple of the minimum ink quantity.

The method of FIG. 3b starts with step 311, in which the total ink quantity to be applied is determined for each ink. It can, for example, be smaller than the maximum ink quantity which can be ejected by a printing nozzle during one printing operation, but it can also be larger, namely up to twice the maximum ink quantity which can be ejected.

Subsequently, in step 312, the partial ink quantities to be applied in the individual printing operations are determined for the corresponding color.

Several variants are conceivable here. In a first case 313, the ink quantity to be applied is n times the minimum ink quantity (but in these embodiments is less than twice the maximum ink quantity which can be ejected by the print head).

If the ink quantity is an even multiple n=2m of the minimum ink quantity (case 331), the partial ink quantity for each of the printing operations can be set to value m 332. This means that the partial ink quantity corresponds m times the minimum ink quantity. It is less than or at most equal to the maximum ink quantity which can be ejected during one printing operation. In this case, ink droplets of the same size are ejected from the relevant printing nozzle during each printing operation.

In another case 333 the ink quantity is an odd multiple of the minimum ink quantity n, n=2m+1.

In this case, the partial ink quantity to be applied during one of the printing operations is set to value m and the ink quantity to be applied during the other printing operation is set to value m+1, so that a total of 2m+1=n as ink quantity (measured in minimum ink quantities) has been applied to the container after completion of the two printing operations (step 334).

This embodiment ensures that ink droplets of as equal or approximately as equal size as possible are ejected from the printing nozzle during each printing operation. This results in ink droplets of approximately the same size being produced during each printing operation, so that potentially detrimental print quality effects, such as insufficient spreading of the ink on the substrate, can be avoided or reduced. In particular in embodiments in which the container is continuously rotated, unintentional bleeding of a specific pixel of the printing image can be avoided even if two printing operations are necessary to produce the required ink quantity.

In an alternative embodiment, the determined total ink quantity to be applied to a pixel is again an n-fold multiple of the minimum ink quantity 314.

However, in that case the partial ink quantities k₁ and k₂ for the respective printing operations are not determined such that the ink quantity ejected by the printing nozzle of the print head during each printing operation is the same or almost the same, but the partial quantities are determined such that during one of the printing operations, the total ink quantity or as large a part as possible of the total ink quantity to be applied is applied.

In this embodiment (step 315), the partial ink quantity k₁ is therefore set to value n, provided that the total ink quantity to be applied is less than or equal to the maximum ink quantity which can be ejected by the print head during one printing operation. Otherwise, if the ink quantity to be applied is more than the maximum ink quantity which can be applied during one printing operation, the partial ink quantity k₁ is set to the maximum ink quantity.

Accordingly, the partial ink quantity k₂ is set to value 0 (step 315) if the partial ink quantity k₁ already represents the total ink quantity n (first case in the discussion of k₁). Otherwise, the partial ink quantity k₂ is set as the difference between the ink quantity n to be applied minus the partial ink quantity k₁.

Indices 1 and 2 do not indicate a chronological order of the respective printing operations, so that the partial ink quantity k₁ can be applied either during the first printing operation or during the second printing operation. Accordingly, the partial ink quantity k₂ is applied either during the second or first printing operation. This embodiment ensures that the substantial part of the ink quantity to be applied (except in the case where the ink quantity to be applied corresponds to twice the maximum ink quantity) is applied during one of the printing operations. This means that an as large as possible ink droplet is produced during this printing operation and ejected to the surface of the container, which reduces negative effects on the printing image, such as those caused by airflow. The partial ink quantity k₂ that is smaller compared thereto may be subject to such effects, but due to its comparatively small contribution to the total ink quantity to be applied is less detrimental to the result.

As already mentioned above, the variation of the droplet size of a print head, but also of different print heads, can deviate from the case discussed with reference to FIG. 3b, so that the difference in the size of two different ink droplets does not correspond to an integer multiple of the minimum ink droplet size. For example, while in ideal cases the printing nozzle of an inkjet print head can eject ink droplets with a size of 0 (no ink droplet) to 35 pl, namely in discrete partial steps of 5 pl, in reality there may be a deviation from this exactly linear case without compensation of the control signals. For example, the ink droplets can have a size of 6 pl, 13 pl, 16 pl, 21 pl, 23 pl, 31 pl and 37 pl.

Corresponding deviations from the ideal linear distribution of the size of the ink droplets can also occur for other print heads, which ultimately leads to ink droplets of different sizes being ejected despite the substantially equal ink quantity to be applied, or to ink droplets of different sizes of one color not differing by the desired ink quantity. This leads to undesirable ink deviations, in particular in embodiments in which two (or even more) printing operations are carried out in order to achieve the highest possible ink saturation or the largest possible color space, since the resulting differences can grow with the number of printing operations or are not large enough.

FIG. 4 shows a method by which these deviations can be corrected either as part of the method of one of the previous embodiments or separately, for example when commissioning the apparatus according to FIG. 1.

First, the maximum ink droplet size of a print head and/or of each print head is determined in a first step 401. Subsequently, the (maximum) ink quantities 402 which can be ejected by the inkjet print heads are adjusted.

This can be done in different ways. For example, if it has been found during determination of the maximum ink droplet sizes that they differ for different print heads, the maximum ink droplet size can be adjusted in step 403. For example, if it is found that a first print head ejects ink droplets with a maximum size of 30 pl, but a second print head ejects ink droplets with a size of 32 pl, the maximum ink quantity of the print head that can eject 32 pl ink droplets can be reduced, or the ink droplet size of the print head that can eject 30 pl ink droplets can be increased. This can be achieved by changing the control signals supplied to the inkjet print heads so that, for example, the piezo elements are operated differently, for example by having different activation times in order to influence the ejection of ink droplets from the individual printing nozzles.

It may also happen that different print heads provide a different number of partial steps or different discrete ink droplet sizes. For example, two print heads that can produce the same maximum ink droplet size may differ in terms of the intermediate sizes of the ink droplets. For example, a first print head may allow five intermediate sizes, while a second print head may allow up to seven. However, when determining the color values, this means that the second print head can produce more detailed ink differences that the first print head cannot produce, so that the first print head assigns the same ink droplet size to a larger range of pixel color values of a digital printing image, while the other print head may use different ink droplet sizes and thus different ink quantities.

This can have a detrimental effect on the quality of the printing images produced and can be caused by switching off partial steps 404 of the print head, which can eject a larger number of ink droplets of different sizes. For example, instead of seven, only five different sizes of ink droplets can be realized by suitable control signal settings.

If, instead or in addition, the sizes of the ink droplets differ in the individual partial steps, an adjustment can be made here as well by changing the control signals. This applies not only to different print heads, but also to a single print head. For example, if the factory setting of a single print head means that the changes in ink droplet size do not occur in integer multiples of 5 pl (see the above example), changing the control signals can result in that these differences are compensated for or at least minimized 405.

Such linearization can also be carried out between different print heads, so that the ink droplets of the different print heads can be ejected in as uniform sub-sizes as possible, which are identical in size for each print head.

With the ink quantities adjusted in this way, the control signals for the individual print heads can then be adjusted in step 406.

With control signals adjusted in this way, an ink quantity to be applied can then be determined, for example based on the printing images obtained in step 201 (see FIG. 2), and ultimately the inkjet print heads can be controlled.

1. A method for printing a container, such as a bottle, with a printing image using one inkjet print head per ink, the method comprising determining an ink quantity to be applied to the container in a manner which is dependent on the printing image to be applied for each ink, and applying the ink quantity to be applied by each inkjet print head, wherein at least one of the inkjet print heads applies the ink quantity to be applied to the container in two printing operations, wherein a partial ink quantity is applied to the container in each printing operation in a manner which is dependent on the ink quantity to be applied, wherein the partial ink quantity in each printing operation corresponds to up to the maximum ink quantity which can be ejected by the inkjet print head.

2. The method according to claim 1, wherein at least two inkjet print heads eject an ink droplet from a printing nozzle in a printing operation and the size of the ink droplet is determined as a function of the partial ink quantity to be applied, wherein the size of the ink droplet can be adjusted in discrete partial steps from 0 up to a maximum ink droplet size as a function of the partial ink quantity to be applied.

3. The method according to claim 2, wherein the method further comprises adjusting the ink quantity ejected by the at least two inkjet print heads.

4. The method according to claim 3, wherein the at least two inkjet print heads can eject maximum ink droplet sizes that differ from one another and the adjustment is carried out based on the maximum ink droplet sizes.

5. The method according to claim 4, wherein the adjustment comprises changing a control signal for at least one inkjet print head.

6. The method according to claim 1, wherein the determination comprises deriving color values from the printing image to be applied, wherein the color values correspond from 0 up to a maximum color value corresponding to the maximum ink quantity which can be ejected by the inkjet print head, and determination further comprises doubling the derived color values, wherein the ink quantity to be applied is determined based thereon.

7. The method according to claim 1, wherein the determination comprises deriving color values from the printing image to be applied, wherein the color values correspond from 0 to twice a maximum color value corresponding to the maximum ink quantity which can be ejected by the inkjet print head, wherein the ink quantity to be applied is determined based thereon.

8. The method according to claim 6, wherein determining the ink quantity to be applied further comprises determining the partial ink quantity to be applied as a function of the ink quantity to be applied.

9. The method according to claim 1, wherein the ink quantity to be ejected corresponds to at least twice the value of a minimum ink quantity which can be ejected by the inkjet print head, and the partial ink quantity for each printing operation corresponds to at least the minimum ink quantity which can be ejected by the inkjet print head; or wherein the ink quantity to be applied corresponds to at least twice the value of a minimum ink quantity which can be ejected by the inkjet print head and the partial ink quantity for a printing operation is selected to be as large as possible depending on the ink quantity to be applied and the maximum ink quantity which can be ejected by the inkjet print head, wherein, if the ink quantity to be applied corresponds to more than the maximum ink quantity which can be ejected by the inkjet print head, the difference between the ink quantity to be applied and the maximum ink quantity which can be ejected is defined as the partial ink quantity in the second printing operation.

10. The method according to claim 1, wherein the method further comprises curing the applied partial ink quantity by a curing device after each printing operation.

11. An apparatus for printing containers, such as bottles, with a printing image, the apparatus comprising an inkjet print head for ejecting an ink and a control unit for controlling the ejection of ink by the respective inkjet print heads, wherein the apparatus is configured to carry out a method for printing a container with a multi-color printing image, the method comprising determining an ink quantity to be applied to the container in a manner which is dependent on the printing image to be applied for each ink, and applying the ink quantity to be applied by each inkjet print head, wherein at least one of the inkjet print heads applies the ink quantity to be applied to the container in two printing operations, wherein a partial ink quantity is applied to the container in each printing operation in a manner which is dependent on the ink quantity to be applied, wherein the partial ink quantity in each printing operation corresponds to up to the maximum ink quantity which can be ejected by the inkjet print head.

12. The apparatus according to claim 11, wherein the apparatus comprises a curing device which is arranged such that a partial ink quantity ejected can be cured after each printing operation.
